(19) United States
(12) Patent Application Publication
(10) Pub. No.: US 2017/0068602 A1
(43) Pub. Date: Mar. 9, 2017

(54) INCLUSION OF ADDITIONAL RECORDS FOR MANAGING AN EXISTING REPLICATION SYSTEM CONSISTENCY GROUP

(71) Applicant: International Business Machines Corporation, Armonk, NY (US)

(72) Inventors: Paul M. Cadarette, Hemet, CA (US); Joseph L. Kidd, Fish Creek, WI (US); Robert D. Love, Littleton, NC (US); Austin J. Willoughby, Voorheesville, NY (US)

(21) Appl. No.: 14/848,145

(22) Filed: Sep. 8, 2015

(51) Int. Cl. G06F 11/14; G06F 17/30

(52) U.S. Cl. CPC G06F 11/1469; G06F 11/1451; G06F 11/1435; G06F 11/1438; G06F 11/1464; G06F 17/30371; G06F 17/30377; G06F 17/30575; G06F 2201/84; G06F 2201/80

(57) ABSTRACT

Provided are a method, a system, and a computer program product for supporting recovery of a replication system, in which a first full recovery identification is recorded for a first set of dependent writes for a first object and subsequent abbreviated change records are recorded for the first object in a recovery repository. A second set of writes are recorded for a second object with abbreviated change record identifications for the second object in the recovery repository. A configurable metadata is utilized for distinguishing between the first set of dependent writes and the second set of writes in the recovery repository to identify the first set of dependent writes as applicable and the second set of writes as not applicable. The first set of dependent writes is recovered in a single pass.

### BACKGROUND

1. Field

Embodiments relate to the inclusion of additional records for managing an existing replication system consistency group.

2. Background

Virtual storage access method (VSAM) is a Direct Access Storage Device (DASD) file storage access method. Data replication in computing involves copying or sharing data so as to ensure consistency between redundant resources, such as software or hardware components. In a data replication system VSAM clusters are grouped into collections that belong to an individual workload, application or consistency group. Replication activities may be started and stopped for a consistency group. However, it may be necessary to establish a point at which change data capture starts for each individual VSAM cluster within the consistency group. When a new VSAM cluster is to be added, a time may have to be established for its log reading to begin.

Replication systems may replicate at the VSAM cluster level. This ensures that even if the VSAM cluster is opened under a new file name in a logging application the changes for the VSAM cluster are captured. Missing any changes related to the VSAM cluster name may result in data inconsistencies in the replica.

For VSAM change data capture, log records are not written with the VSAM cluster name, where VSAM cluster name has a maximum size of 44 bytes. Each log record may contain an 8 byte file name that is unique to the application that writes the log record. To relate the 8 byte application name to the longer VSAM cluster name used by a replication system, logging applications periodically write “tieup” records. A tieup record is written each time a file is opened under control of a logging application and periodically while the VSAM cluster remains open. The interval for the periodic writing may vary depending on activity of the logging application.

### SUMMARY OF THE PREFERRED EMBODIMENTS

Provided are a method, a system, and a computer program product for supporting recovery of a replication system, in which a first full recovery identification is recorded for a first set of dependent writes for a first object and subsequent abbreviated change records are recorded for the first object in a recovery repository. A second set of writes are recorded for a second object with abbreviated change record identifications for the second object in the recovery repository. A configurable metadata is utilized for distinguishing between the first set of dependent writes and the second set of writes in the recovery repository to identify the first set of dependent writes as applicable and the second set of writes as not applicable. The first set of dependent writes is recovered in a single pass.

### BRIEF DESCRIPTION OF THE DRAWINGS

Referring now to the drawings in which like reference numbers represent corresponding parts throughout:

FIG. 1 illustrates a block diagram of a computing environment comprising a computational device that manages the replication of data from a source data store to a target data store, in accordance with certain embodiments;

FIG. 2 illustrates a block diagram that shows generation of tieup records, in accordance with certain embodiments;

FIG. 3 illustrates a block diagram that shows the generation of tieup collection for consistency group, in accordance with certain embodiments;

FIG. 4 illustrates a block diagram that shows the generation of an of interest tieup collection and a not of interest tieup collection, in accordance with certain embodiments;

FIG. 5 illustrates a block diagram that shows the addition of a selected file to the consistency group, in accordance with certain embodiments;

FIG. 6 illustrates a block diagram that shows the removal of a selected file to the consistency group, in accordance with certain embodiments;

FIG. 7 illustrates a flowchart for generating two types of tieup records, in accordance with certain embodiments;

FIG. 8 illustrates a flowchart for supporting recovery of a replication system, in accordance with certain embodiments;

FIG. 9 illustrates a block diagram of a computational system that shows certain elements that may be included in the computational device of FIG. 1, in accordance with certain embodiments.

### DETAILED DESCRIPTION

In the following description, reference is made to the accompanying drawings which form a part hereof and which illustrate several embodiments. It is understood that other embodiments may be utilized and structural and operational changes may be made.

Problems with maintaining tieup collections for consistency group only

A log reader application may be unable to associate logged change data between a specific VSAM cluster name and an application's file name without tracking the tieup record. If a replication system is aware of a specific set of VSAM cluster names being “of interest” from a specific replication log, it may decide to only track the tieup records related to that set. Each time a tieup record is seen for the set of tracked VSAM clusters, the matching tieup record is updated and if the VSAM cluster is closed the logged close record causes tieup tracking to be removed.

The earliest tracked tieup record at the start of each update is retained in a restart token (also referred to as a bookmark) to allow the replication system (also referred to as a replication configuration) to rebuild the required set of tieup records on restart. This allows the replication system to rebuild its tieup collection prior to reaching the point in the log where required logged change data is to be captured.

When a new VSAM cluster is to be added into the consistency group, replication activities may have to be stopped and the point at which change data capture starts may have to be noted. To allow the log reader to associate logged change data for the newly added VSAM cluster a tieup must be guaranteed after the point at which data was refreshed to the target replica. To guarantee this, the source VSAM cluster may need to be closed by all writers in all logging applications and then reopened.

Existing solutions filter the VSAM clusters in the consistency group and only those VSAM clusters are tracked. Any VSAM clusters outside the set in the consistency group that are found in the log would be ignored for efficiency.

Other solutions require the log reader to read in reverse when a new VSAM cluster is added. This can be costly because a lot of log data may need to be read to locate the last tieup record for the newly added VSAM cluster.

### Of Interest and not of Interest Types of Tieup Collections

Certain embodiments provide a mechanism in which a replication system may dynamically add existing VSAM clusters found in the replication log into a consistency group without requiring the VSAM cluster access to be quiesced and all logging applications to issue a close and reopen. A replication system may not require back-scanning and rereading of blocks to find tieup records when a new VSAM cluster is added into the consistency group. The ability to have a flexible product less reliant on manual user steps (i.e. closing and re-opening the VSAM cluster in each logging application) may have considerable value to avoid service calls and improve user experience.

The embodiments may be based on observations that some additional tracking of VSAM clusters outside the consistency group set may slightly increase processing costs, but drastically improves usability of the replication system. The additional costs are related to tracking additional tieup records that may or may not be used in the future as well as, possibly, restarting log scanning further back after restarts to find the tieup records to rebuild the tieup collection.

Certain embodiments track all tieup records, not only the set of VSAM clusters in the consistency group. Every tieup and file close record are processed and take part in determining the tieup information in the restart token. This allows the replication system to add any VSAM cluster to the consistency group that is found in the replication log for the consistency group without the onerous requirement of ensuring the VSAM cluster is closed and reopened in each logging system. Such embodiments make it simpler for users to activate replication for a VSAM cluster by making the process of adding it to the consistency group more flexible since the VSAM cluster may be added to the consistency group at a convenient time without requiring the user to close and reopen the VSAM cluster to generate tieup records.

Certain embodiments may read and forward any tieup record found in the replication log without respect to VSAM cluster filtering associated with the consistency group's current contents to the component responsible for determining the log scan start point for the restart token.

The log reader application may use two lists to track tieups for VSAM clusters found in the replication log—VSAM clusters within the consistency group (i.e., the “of interest” set) and VSAM clusters found in the replication log that are not in the consistency group (i.e., the “not of interest” set). Change data may be filtered against the list of “of interest” VSAM clusters. Tieup and file close records are processed regardless of which list the associated VSAM cluster is currently on.

If the consistency group is stopped and restarted, a VSAM cluster may move from the “not of interest” list to the “of interest” list. This occurs if the VSAM cluster is added into the consistency group. Since all tieup records are being tracked, the new VSAM cluster's tieup is already included in the log scan determination and on restart when the tieup collection is rebuilt, the newly added VSAM cluster's tieup record(s) may be read and placed in the “of interest” list rather than the “not of interest” list. Any change data seen after the tieup record is found are processed.

When the new VSAM cluster is added its contents are either refreshed to the target internally within the replication system or externally through some other process and the point of source/target data consistency is noted in the metadata for the newly added VSAM cluster. Any change data captured between where log scanning finds the tieup record and starts processing changed data for the newly added VSAM cluster and the time of source/target data consistency are discarded.

Certain embodiments specifically deal with adding a new VSAM cluster into an existing consistency group. A new consistency group may always contain at least one VSAM cluster that was closed at the point of source/target data consistency. This allows the consistency group to be started and have log reader application find the tieup records associated with re-opening the VSAM cluster(s).

It is possible to use certain embodiments with new consistency groups by establishing a “dummy” VSAM cluster (a manufactured VSAM cluster that doesn't belong to the source application or any source application) to initialize the consistency group and then the embodiments may be utilized to progressively add each VSAM cluster in the workload into the consistency group later. This could be at a later time when the VSAM cluster is defined for replication logging or, for a VSAM cluster already defined for replication logging, after a sufficient period to ensure a tieup record is available. Log reading utilities may be used to ensure the presence of the tieup record after the point of log reading when not obvious.

In certain embodiments, tieup records are found for any VSAM cluster in the replication log without causing a procedural step to close and re-open the VSAM cluster to generate tieup records. Without such embodiments, a newly added VSAM cluster could be open when the source and target images are equalized. Restarting the replication system for the consistency group may not find the tieup record after the log scan start time and before change data for the newly added VSAM cluster. If that occurs, the log reader application may discard changes until the next tieup record for the newly added VSAM cluster is found. This may result in a data consistency problem between the source and target and may cause replication to fail for the consistency group.

Processing tieup records currently “not of interest” to the consistency group provides benefit by assisting in adding new VSAM clusters into the consistency group. This approach is preferable over imposing procedural steps on the user or reading in reverse (i.e. back-scanning) to locate the tieup records. The cost is relatively small and controllable by limiting what is in the replication log for the consistency group. Solutions that use back-scanning also have associated costs and it is difficult to quantify, but the cost of tracking all tieups is cheaper than back-scanning and rereading log blocks while searching for tieups.

### Exemplary Embodiments

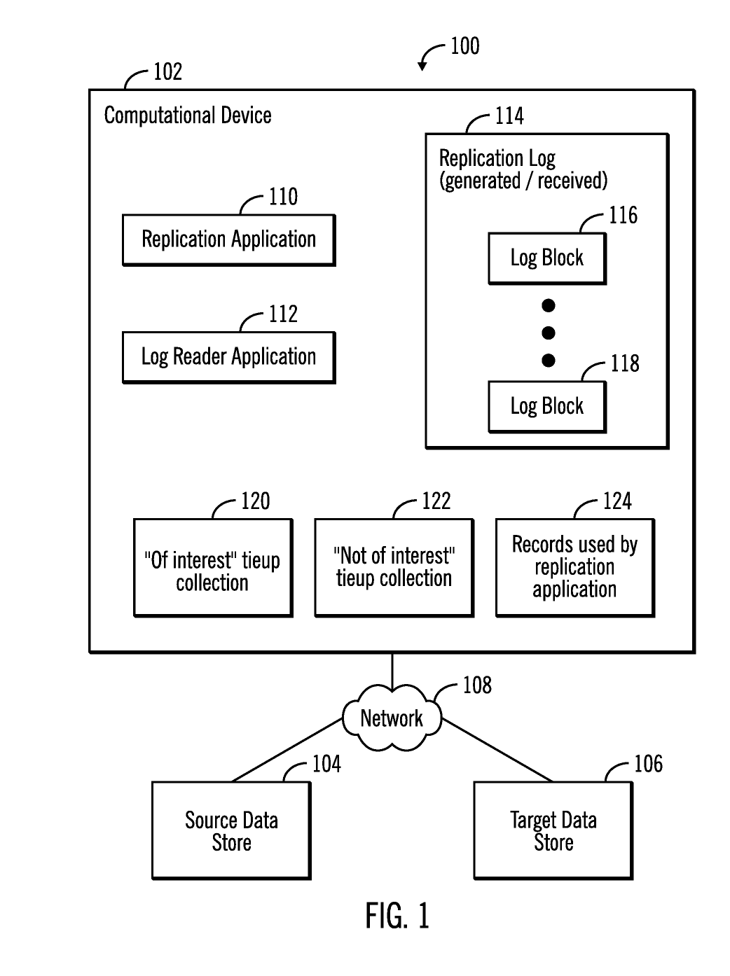

FIG. 1 illustrates a block diagram of a computing environment 100 comprising a computational device 102 that manages the replication of data from a source data store 104 to a target data store 106.

The computational device 102 comprise any suitable computational device including those presently known in the art, such as, a personal computer, a workstation, a server, a mainframe, a hand held computer, a palm top computer, a telephony device, a network appliance, a blade computer, a processing device, etc. The computational device 102, the source data store 104 and the target data store 106 may be elements in any suitable network 108, such as, a storage area network, a wide area network, the Internet, an intranet. In certain embodiments, computational device 102, the source data store 104 and the target data store 106 may be elements in a cloud computing environment.

A replication application 110 and a log reader application 112 may execute in the computational device 102. The replication application 110 and the log reader application 112 may be implemented in software, firmware, hardware or any combination thereof and may in certain embodiments be components of the same application.

The replication application 104 replicates data consistently between the source data storage 104 and the target data store 106. The source data store 104 and the target data store 106 may be geographically separated and may be on different storage devices. However, other configurations of the source data storage 104 and target data store 106 are possible in certain embodiments.

The log reader application 112 reads a replication log 114 that is generated or received by the computational device 102 during the process of replication from the source data store 104 to the target data store 106. The replication log is comprised of a plurality of log blocks 116, 118.

In certain embodiments, the log reader application 112 processes the replication log 114 and generates of interest tieup collections 120, not of interest tieup collections 122, and records 124 used by the replication application 110.

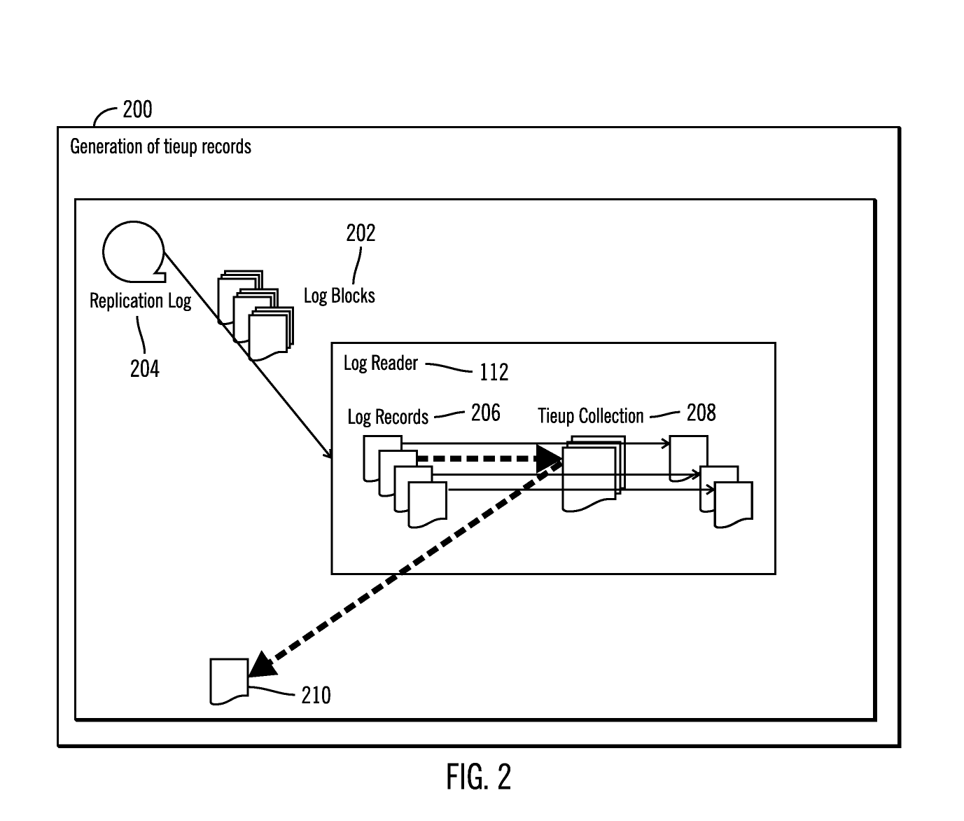

FIG. 2 illustrates a block diagram 200 that shows generation of tieup collections (i.e., records), in accordance with certain embodiments. In existing solutions, log blocks 202 from the replication log 204 are received by the log reader application 112 and broken into log records 206. Tieup log records 208 matching data sets in the consistency group are used to build the tieup collection. Any log record 210 that does not match a tieup record in the tieup collection is discarded as shown via the dashed bolded lines.

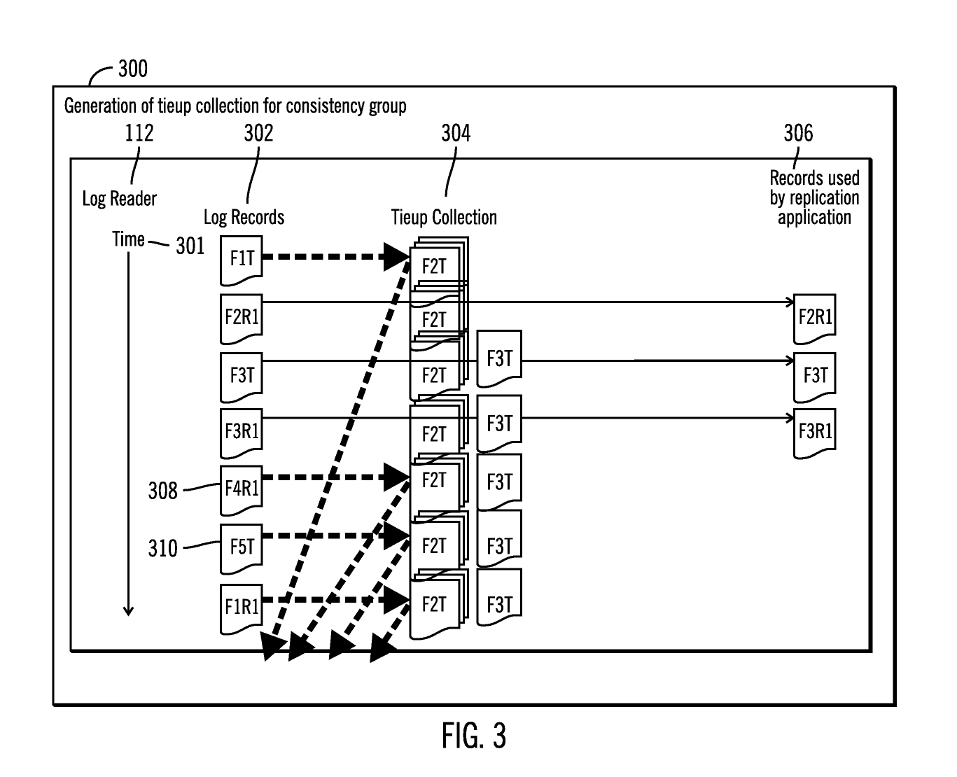

FIG. 3 illustrates a block diagram 300 that shows generation of tieup collection for consistency group, in accordance with certain embodiments. In FIG. 3, the passage of time is shown via reference numeral 301.

In existing solutions only log records 302 for files in the tieup collection 304 are sent through to the receiver of the log reader application's 112 processing (as shown via reference numeral 306 that shows the records used by the replication application which may be the receiver of the log reader application's processing). In FIG. 3 each log record is indicated by the file it pertains to by Fn (File and a number) and within each file each record is either a FnT (tieup for file n) or a data change record for a file (FnRm). For example, F4R1 308 represents data change record number #1 for file #4, and F5T 310 represents tieup record for file #5. Discarded records are indicated by dashed lines showing they are not sent to the receiver, but are instead discarded by the component.

On restarts the tieup collection is rebuilt using the oldest tieup that was in the collection when the last unit of recovery (UOR) applied started, where a UOR is a group of transactions or operations that are either committed or backed out as a group, i.e., transactions or operations that are applied together. That is, the bookmark (i.e., the restart token) for the consistency group contains information that allows the replication system to rebuild the tieup collection if a restart is needed.

The deficiency of existing solutions is that if replication for the consistency group is stopped after all records in FIG. 3 were processed and committed to the target and then file #1 is added into the consistency group, the tieup for file #1 would not be included when the log reader application 112 rebuilds the collection of tieup records for the consistency group. This would cause any records for file #1 to be discarded until a tieup was seen in the log, which could be a lengthy period. When change data records do eventually flow after a tieup record is processed it is likely a data inconsistency would be reported by the replication system since change data records were likely missed.

Existing solutions that only track tieup records for data sets in the consistency group would require the data set pertaining to file #1 to be closed in all address spaces when file #1 is added to the consistency group. In today's high availability production systems it may be an onerous requirement to need to close a data set in order to include it in a consistency group for replication. This may limit the windows of time when data sets may be added into a consistency group.

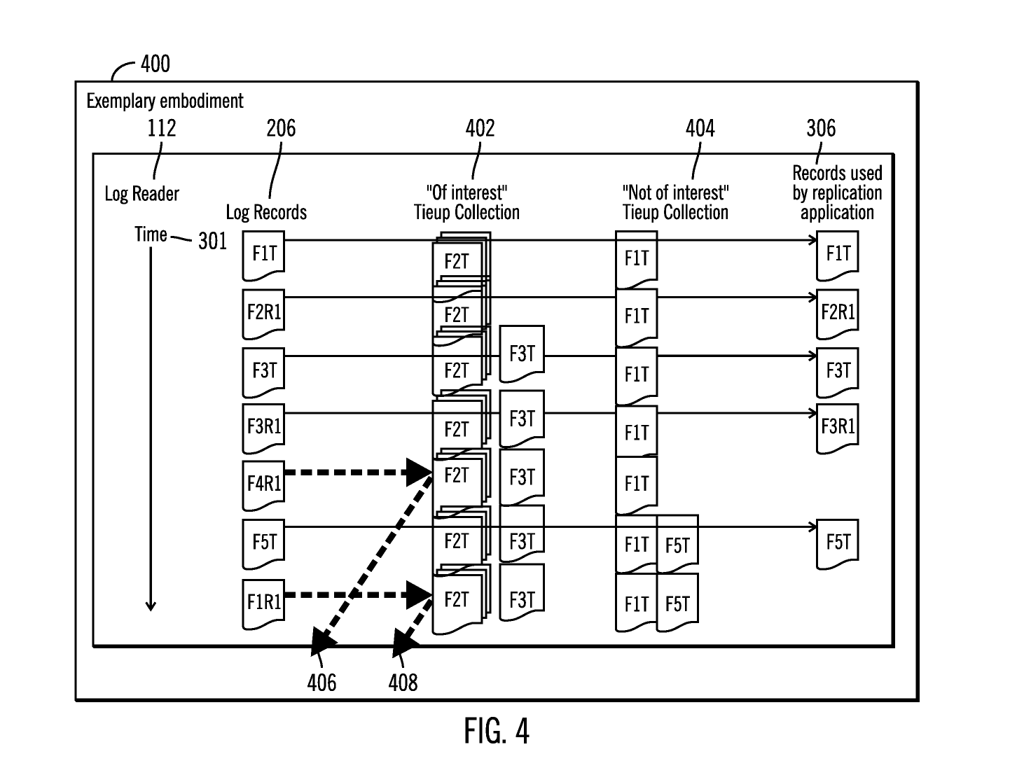

FIG. 4 illustrates a block diagram 400 that shows the generations of an of interest tieup collection 402 and a not of interest tieup collection 404, in accordance with certain embodiments;

FIG. 4 shows two collections of tieup records via the log reader application 112. Any tieup processed will either be tracked by the “of interest” 402 or the “not of interest” 404 tieup collections and forwarded to the receiver for use in determining the correct information to store in each UORs bookmark information for restart processing. Records for any file not found in the “of interest” tieup collection 402 will be discarded by the log reader application 112 (as shown via reference numerals 406, 408).

On restarts the tieup collection is rebuilt using the oldest tieup that was in the collection when the last UOR applied started. That is, the bookmark for the consistency group contains information that allows the replication system to rebuild the tieup collection if a restart is needed.

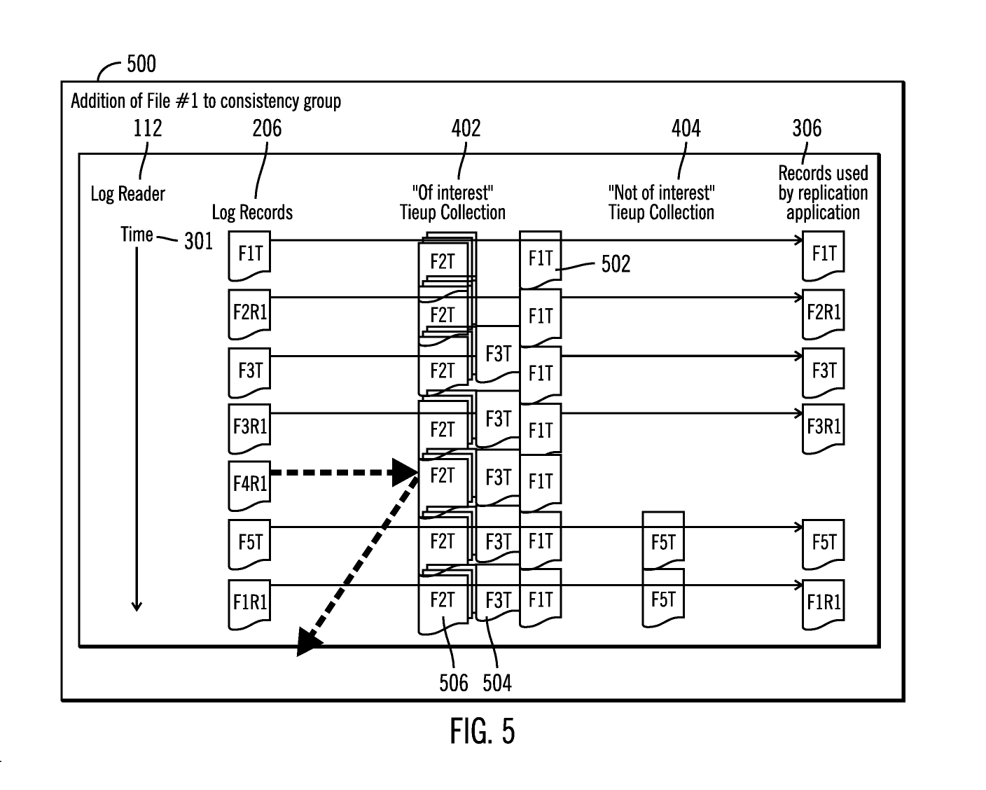

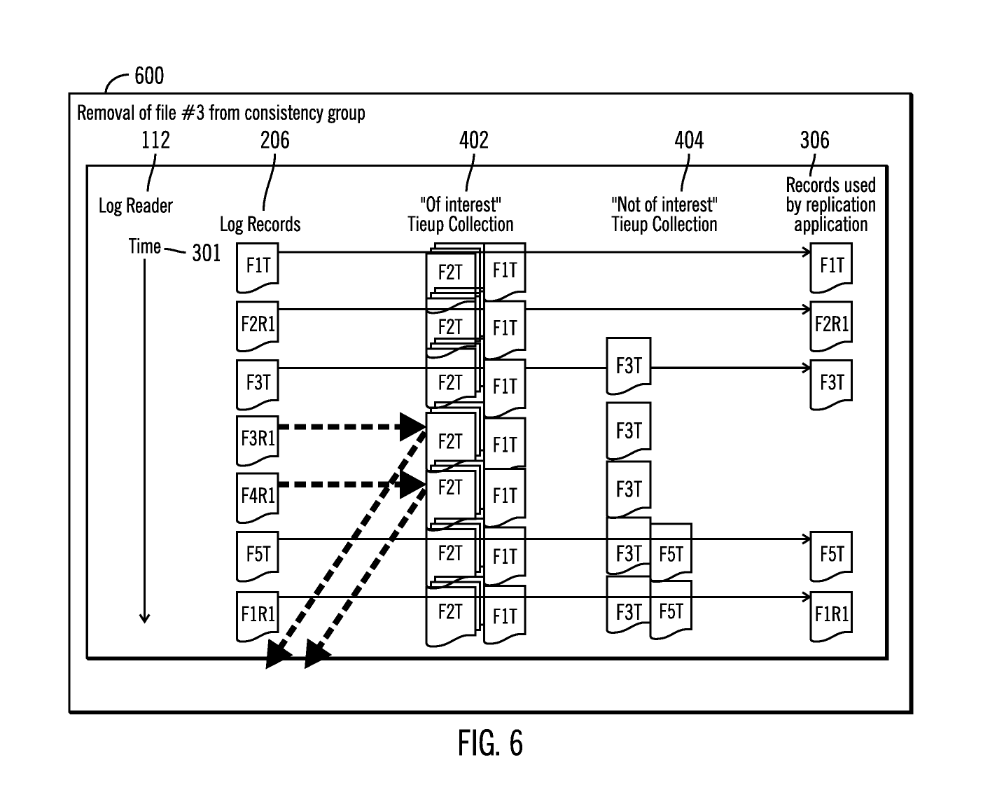

On restart the collection could be rebuilt with all tieup information and file #1 could move from the “not of interest” tieup collection 400 to the “of interest” tieup collection 402. The following FIGS. 5 and 6 show what would happen if the system restarted and reprocessed this information. Note, this is a simplified example that is meant to be demonstrative of the process, but should not limit the disclosure from other more complicated embodiments.

FIG. 5 illustrates a block diagram 500 that shows the additional of a selected file (File #1) to the consistency group, in accordance with certain embodiments. It can be seen that the tieup record for file #1 has been added to the of interest tieup collection 402 as shown by reference numeral 502. The tieup record of file #3 is shown via reference numeral 504, and the tieup record of file #2 is shown via reference numeral 506. Once the tieup record for file #1 has been added, it remains in the of interest tieup collection 402 with the passage of time 301 unless explicitly removed. Processing can therefore be restarted if file #1 has been added to the consistency group.

FIG. 6 illustrates a block diagram 600 that shows the removal of a selected file (file #3) from the consistency group, in accordance with certain embodiments. It can be seen that the tieup record for file #3 504 has been removed from the of interest tieup collection 402 (shown in FIG. 5) in comparison to the embodiment shown in FIG. 5. Processing can therefore be restarted if file #3 has been removed from the consistency group.

From FIGS. 4, 5, 6 it may be seen that the log reader 112 passes to the replication application the tieup and data records of files whose tieup records are found in the of-interest tieup collection and also passes to the replication application 110 the tieup records of those files whose tieup records are found in the not of interest tieup collection.

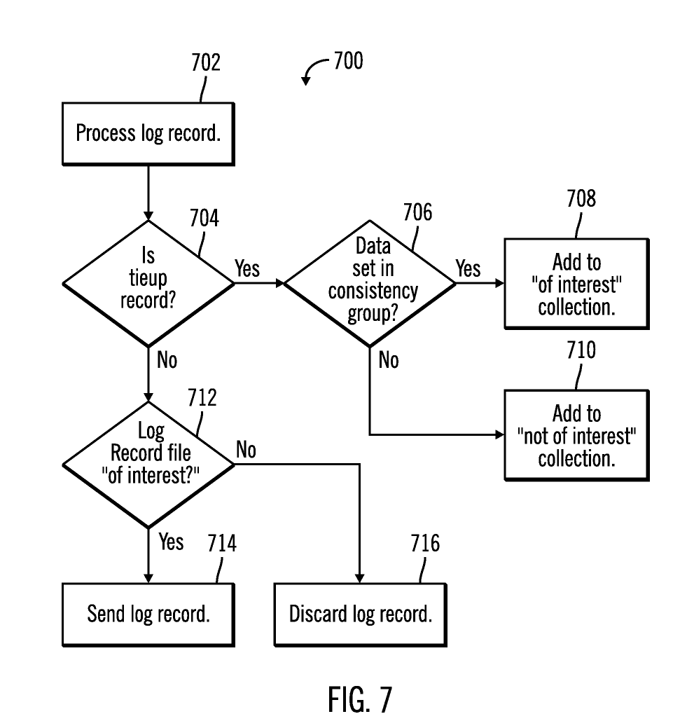

FIG. 7 illustrates a flowchart 700 for generating two types of tieup records, in accordance with certain embodiments. The operations shown in FIG. 7 may be performed by the computational device 102 via at least the log reader application 112.

Control starts at block 702 in which the log reader application 112 processes a log record. A determination is made as to whether the log record is a tieup record (at block 704). If the log record is a tieup record then control proceeds to block 706 in which a determination is made as to whether the data set is in a consistency group. If so, then the tieup record is added to the of interest tieup collection (as shown via reference numeral 708). If not, then the tieup record is added to the not of interest tieup collection (as shown via reference numeral 710). The tieup record is always transmitted for further processing.

If at block 704 it is determined that the log record is not a tieup record then control proceeds to block 712 where a determination is made as to whether the log record file's tieup record in the of interest tieup collection. If so, then the log record is sent (at block 714) for further processing. If not, then the log record is discarded (at block 716).

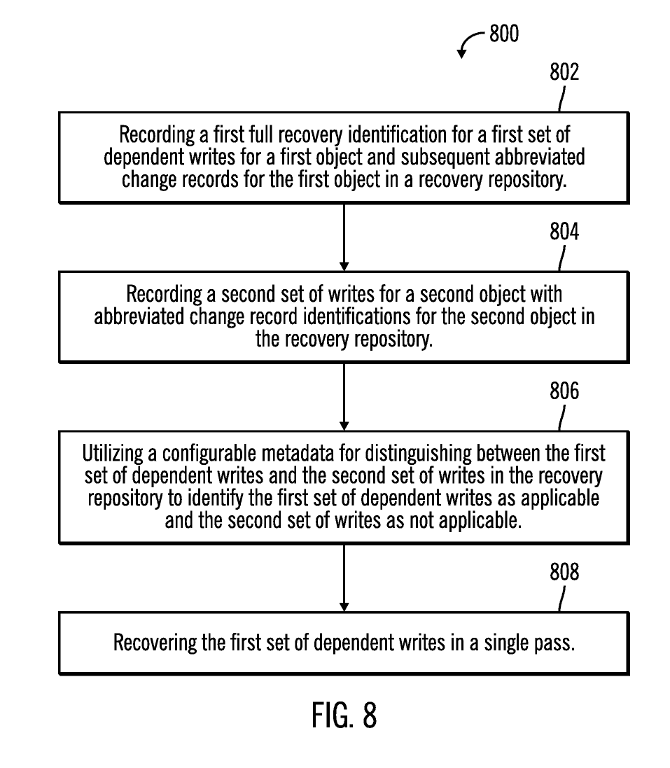

FIG. 8 illustrates a flowchart 800 for supporting recovery of a replication system, in accordance with certain embodiments. The operations shown in FIG. 8 may be performed by the computational device 102 via at least the log reader application 112.

Control starts at block 802, in which a first full recovery identification is recorded for a first set of dependent writes for a first object and subsequent abbreviated change records are recorded for the first object in a recovery repository (e.g., the replication log 114). The dependent writes correspond to a consistency group. A second set of writes are recorded (at block 804 for a second object with abbreviated change record identifications for the second object in the recovery repository. A configurable metadata is utilized (at block 806) for distinguishing between the first set of dependent writes and the second set of writes in the recovery repository to identify the first set of dependent writes as applicable and the second set of writes as not applicable. The first set of dependent writes is recovered in a single pass (at block 808). In certain embodiments, the configurable metadata comprises one or more forms of cluster names that are used to determine tieup records, and wherein the configurable metadata is used to build tieup collections.

Therefore FIGS. 1-8 illustrate certain embodiments that provide a mechanism in which a replication system may dynamically add existing VSAM clusters found in the replication log into a consistency group without requiring the VSAM cluster access to be quiesced and without requiring all logging applications to issue a close and re-open.

### Additional Embodiment Details

The described operations may be implemented as a method, apparatus or computer program product using standard programming and/or engineering techniques to produce software, firmware, hardware, or any combination thereof. Accordingly, aspects of the embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the embodiments may take the form of a computer program product. The computer program product may include a computer readable storage medium (or media) having computer readable program instructions thereon for causing a processor to carry out aspects of the present embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present embodiments.

Aspects of the present embodiments are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention.

In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instruction.

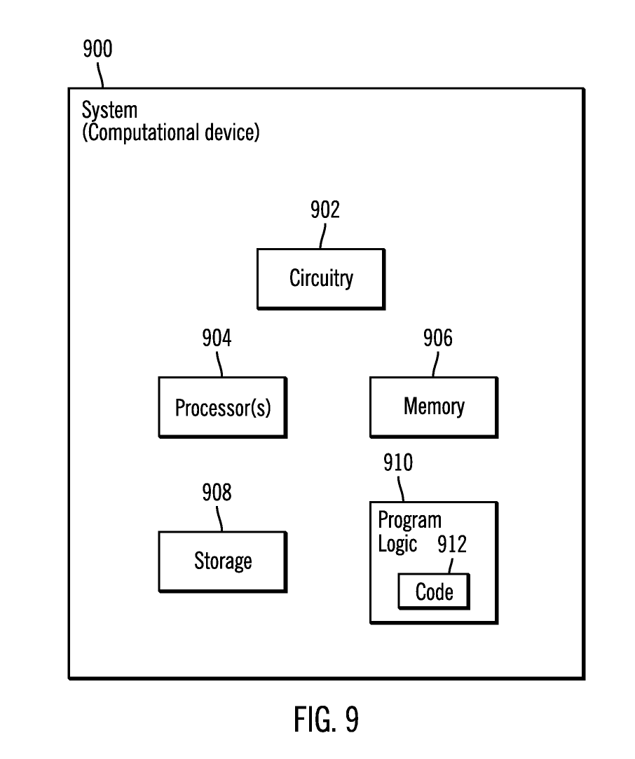

FIG. 9 illustrates a block diagram that shows certain elements that may be included in computational device 102, or other computational devices in accordance with certain embodiments. The system 900 may include a circuitry 902 that may in certain embodiments include at least a processor 904. The system 900 may also include a memory 906 (e.g., a volatile memory device), and storage 908. The storage 908 may include a non-volatile memory device (e.g., EEPROM, ROM, PROM, RAM, DRAM, SRAM, flash, firmware, programmable logic, etc.), magnetic disk drive, optical disk drive, tape drive, etc. The storage 908 may comprise an internal storage device, an attached storage device and/or a network accessible storage device. The system 900 may include a program logic 910 including code 912 that may be loaded into the memory 906 and executed by the processor 904 or circuitry 902. In certain embodiments, the program logic 910 including code 912 may be stored in the storage 908. In certain other embodiments, the program logic 910 may be implemented in the circuitry 902. Therefore, while FIG. 9 shows the program logic 910 separately from the other elements, the program logic 910 may be implemented in the memory 906 and/or the circuitry 902.

Certain embodiments may be directed to a method for deploying computing instruction by a person or automated processing integrating computer-readable code into a computing system, wherein the code in combination with the computing system is enabled to perform the operations of the described embodiments.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

At least certain operations that may have been illustrated in the figures show certain events occurring in a certain order. In alternative embodiments, certain operations may be performed in a different order, modified or removed. Moreover, steps may be added to the above described logic and still conform to the described embodiments.

Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended. affiliates.
IBM, zSeries, pSeries, xSeries, BladeCenter, WebSphere, and DB2 are trademarks of International Business Machines Corporation registered in many jurisdictions worldwide.

What is claimed is:

1. A method for supporting recovery of a replication system, the method comprising:
recording a first full recovery identification for a first set of dependent writes for a first object and subsequent abbreviated change records for the first object in a recovery repository;
recording a second set of writes for a second object with abbreviated change record identifications for the second object in the recovery repository;
utilizing a configurable metadata for distinguishing between the first set of dependent writes and the second set of writes in the recovery repository to identify the first set of dependent writes as applicable and the second set of writes as not applicable; and
recovering the first set of dependent writes in a single pass.

2. The method of claim 1, the method further comprising:
modifying the configurable metadata to process at least one of the second set of dependent writes as applicable after restarting the replication system.

3. The method of claim 2, wherein the modified configurable metadata results from applicable log records related to a specific file that remains open and is read sequentially.

4. The method of claim 3, wherein:
the first set of dependent writes form a consistency group; and
the recovery repository is a replication log.

5. The method of claim 4, wherein the replication log is not read in reverse.

6. The method of claim 1, wherein the configurable metadata comprises one or more forms of cluster names that are used to determine tieup records, and wherein the configurable metadata is used to build tieup collections.

7. The method of claim 6, wherein the tieup collections comprise of interest tieup collections and not of interest tieup collections.

8. A system for supporting recovery of a replication configuration, comprising:
a memory; and
a processor coupled to the memory, wherein the processor performs operations, the operations comprising:
recording a first full recovery identification for a first set of dependent writes for a first object and subsequent abbreviated change records for the first object in a recovery repository;
recording a second set of writes for a second object with abbreviated change record identifications for the second object in the recovery repository;
utilizing a configurable metadata for distinguishing between the first set of dependent writes and the second set of writes in the recovery repository to identify the first set of dependent writes as applicable and the second set of writes as not applicable; and
recovering the first set of dependent writes in a single pass.

9. The system of claim 8, the operations further comprising:
modifying the configurable metadata to process at least one of the second set of dependent writes as applicable after restarting the replication configuration.

10. The system of claim 9, wherein the modified configurable metadata results from applicable log records related to a specific file that remains open and is read sequentially.

11. The system of claim 10, wherein:
the first set of dependent writes form a consistency group; and
the recovery repository is a replication log.

12. The system of claim 11, wherein the replication log is not read in reverse.

13. The system of claim 8, wherein the configurable metadata comprises one or more forms of cluster names that are used to determine tieup records, and wherein the configurable metadata is used to build tieup collections.

14. The system of claim 13, wherein the tieup collections comprise of interest tieup collections and not of interest tieup collections.

15. A computer program product for supporting recovery of a replication system, the computer program product comprising a computer readable storage medium having computer readable program code embodied therewith, the computer readable program code configured to perform operations on a computational device, the operations comprising:
recording a first full recovery identification for a first set of dependent writes for a first object and subsequent abbreviated change records for the first object in a recovery repository;
recording a second set of writes for a second object with abbreviated change record identifications for the second object in the recovery repository;
utilizing a configurable metadata for distinguishing between the first set of dependent writes and the second set of writes in the recovery repository to identify the first set of dependent writes as applicable and the second set of writes as not applicable; and
recovering the first set of dependent writes in a single pass.

16. The computer program product of claim 15, the operations further comprising:
modifying the configurable metadata to process at least one of the second set of dependent writes as applicable after restarting the replication system.

17. The computer program product of claim 16, wherein the modified configurable metadata results from applicable log records related to a specific file that remains open and is read sequentially.

18. The computer program product of claim 17, wherein:
the first set of dependent writes form a consistency group; and
the recovery repository is a replication log.

19. The computer program product of claim 18, wherein the replication log is not read in reverse.

20. The computer program product of claim 15, wherein the configurable metadata comprises one or more forms of cluster names that are used to determine tieup records, wherein the configurable metadata is used to build tieup collections, and wherein the tieup collections comprise of interest tieup collections and not of interest tieup collections.
